(19) United States
(12) Patent Application Publication
(10) Pub. No.: US 2013/0174872 A1
(43) Pub. Date: Jul. 11, 2013

(54) PROLONGED OPERATION HEATER PROTECTION IN AN APPLIANCE

(71) Applicants: William Lee Holbrook, JR., Goshen, KY (US); Dimitrios Iordanoglou, Prospect, KY (US); Jeremy Lowder, Greer, SC (US)

(72) Inventors: William Lee Holbrook, JR., Goshen, KY (US); Dimitrios Iordanoglou, Prospect, KY (US); Jeremy Lowder, Greer, SC (US)

(73) Assignee: GENERAL ELECTRIC COMPANY, Schenectady, NY (US)

(21) Appl. No.: 13/348,071

(22) Filed: Jan. 11, 2012

(51) Int. Cl. A47L 15/42; H05B 1/02

(52) U.S. Cl. 134/19; 219/492

(57) ABSTRACT

An appliance and method for non-thermal heater protection during prolonged operation of the appliance is provided. A time limit determination apparatus may prevent prolonged operation heater protection that prevents significant damage to the appliance.

### FIELD OF THE INVENTION

The subject matter of the present invention relates to the protection of an appliance when a heater is operated for a prolonged period of time.

### BACKGROUND OF THE INVENTION

Consumer appliances, such as dishwashers, washers, dryers, microwaves, cooking ranges, and refrigerators, include a heater for various operations. For example, in dishwashers and washers, the heater may be employed to heat water for washing articles in the respective tubs. In dryers, a heater may be employed to heat the air in a drum. A heater may be energized to cook food in a cooking range and in a refrigerator a heater may be employed for a defrosting operation. For a microwave, a magnetron is the heating element that may be energized to cook food. When a heater is activated during an operation cycle, current flows through the heating element and produces heat. This heat is then used in the operation of the appliance. However, if current continues to flow through the heating element after the selected operation cycle ends, the appliance may be damaged and have to be replaced or serviced before any additional appliance operations resume.

Previously, thermal detection has been used to monitor and prevent heater damage to an appliance. In conventional appliances, a thermal detection device may be coupled to the outer surface of the appliance tub to measure the temperature within the appliance. A thermal detection device detects the temperature within the appliance and then compares the temperature to a preset limit. When the detected temperature exceeds the preset limit, the thermal detection device trips, rendering the appliance inoperable or the heater non-functional until reset by a serviceman. In order to prevent tripping the device when there is no actual problem within the appliance, the preset temperature limit is set significantly higher than normal operating temperatures.

However, the thermal detection device is also influenced by several other factors such as the temperature of the environment surrounding the appliance because it cannot differentiate between the temperature inside and outside the appliance. In addition, noise variables also contribute to the readings of the thermal detection device. Such noise variables include the voltage supplied to the unit (which is may vary within homes from 102V to 132V), wattage variations of the heaters, the temperature of the water supplied to the unit, the insulation within the appliance, the location of the thermal detection device in the appliance, and the load of articles supplied in the appliance to be washed, dried, etc. The thermal detection device receives all of these temperature influences and noise variations and interprets them as an increase or decrease in temperature relative to the preset temperature limit even though the temperature inside the appliance is within normal operating temperature. Therefore, increasing or decreasing the preset temperature limit does not improve the accuracy of the thermal detection device.

In addition, when the preset temperature is increased, the thermal detection device protects consumer safety but may not consistently protect the appliance from significant damage. Due to the high preset temperature limit, the heater may produce enough heat to damage electrical components or to cause tub deformation before the thermal device measures a triggering temperature. Also, if the temperature set point does not account for noise parameters then a false device tripping can occur.

Accordingly, a need exists for providing a non-thermal prolonged operation heater protection in an appliance that is not affected by noise variables and that protects the appliance from significant damage.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a dishwasher appliance including a tub that defines a chamber for receipt of articles for cleaning, a heater for producing heat in the tub, a timer for measuring a duration the heater is activated (T_{ACTIVATE}). The timer includes a timer switch. The dishwasher further includes a controller in communication with the heater, where the controller regulates operation of the dishwasher, and controls the heater based on a selected operation and a time limit determination apparatus that determines when the heater exceeds a predetermined maximum time limit (T_{MAX}). The heater is deactivated when the duration the heater is activated exceeds the predetermined maximum time limit (T_{INT}>T_{MAX}).

In another exemplary embodiment, the present invention provides a method for preventing prolonged heater operation in an appliance. The method includes the steps of regulating operation of the appliance by a controller, controlling a heater based on a selected operation, initiating a timer for measuring a duration the heater is activated during the selected operation, determining whether the heater exceeds a predetermined maximum time limit and deactivating the heater when the duration the heater is activated exceeds the predetermined maximum time limit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, perspective view of an exemplary dishwashing appliance of the present invention.

FIG. 2 provides a side, cross-sectional view of the exemplary embodiment of FIG. 1.

FIG. 3 provides a flow chart of a method for preventing prolonged heater operation according to an exemplary embodiment of the present disclosure.

FIG. 4 provides a circuit schematic according to an exemplary embodiment of the present disclosure.

FIG. 5 provides a circuit schematic according to an exemplary embodiment of the present disclosure.

FIG. 6 provides a flow chart of a method for reactivating a heater after a prolonged heater operation is detected according to an exemplary embodiment of the present disclosure.

FIG. 7 provides a flow chart of a method for managing power outages according to an exemplary embodiment of the present disclosure.

### DETAILED DESCRIPTION OF THE INVENTION

The present invention relates to an appliance and method for non-thermal heater protection during prolonged operation of the appliance. A time limit determination apparatus may prevent prolonged operation heater protection that prevents significant damage to the appliance.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

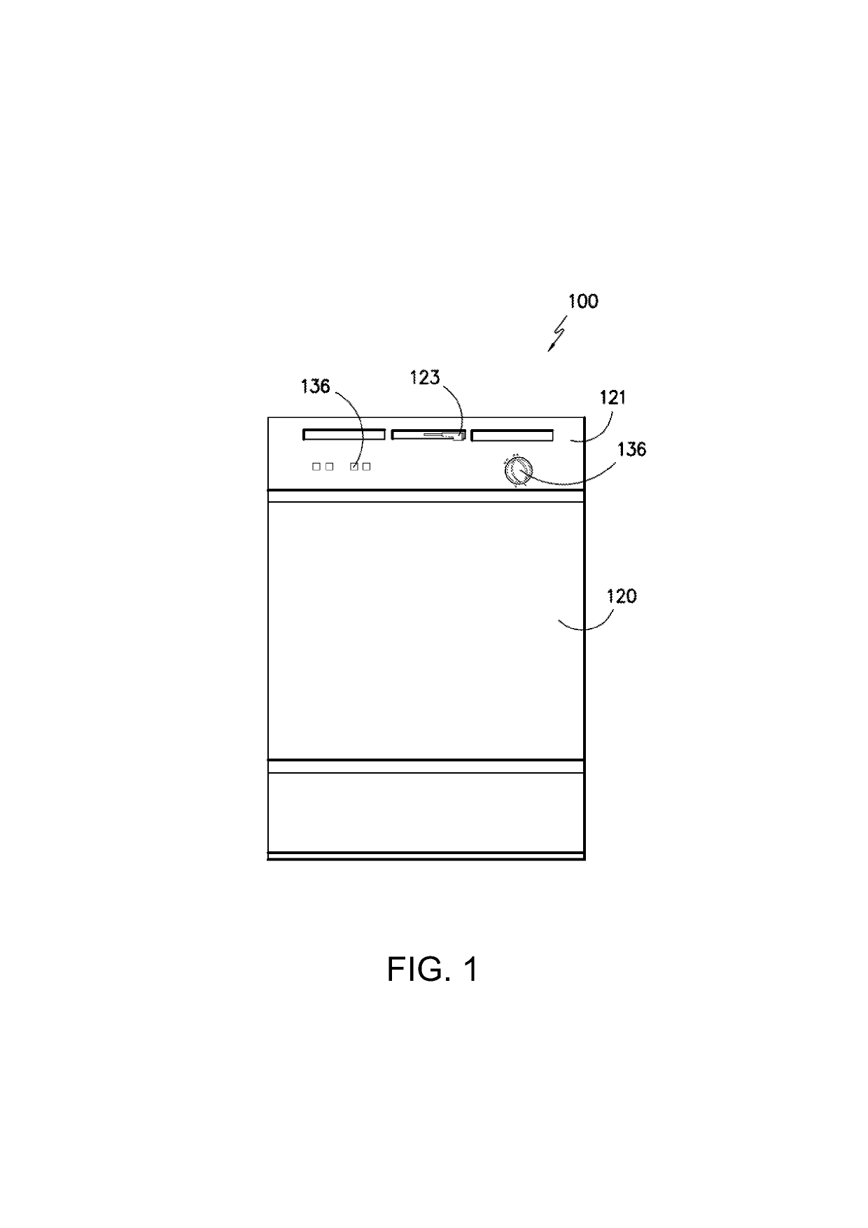

FIG. 1 depicts an exemplary domestic dishwasher 100 that may be configured in accordance with aspects of the disclosure, although it should be understood that the method disclosed herein is not limited to use with dishwashers and may be used with other appliances such as e.g., washing machines, dryers, cooking ranges, and refrigerators.

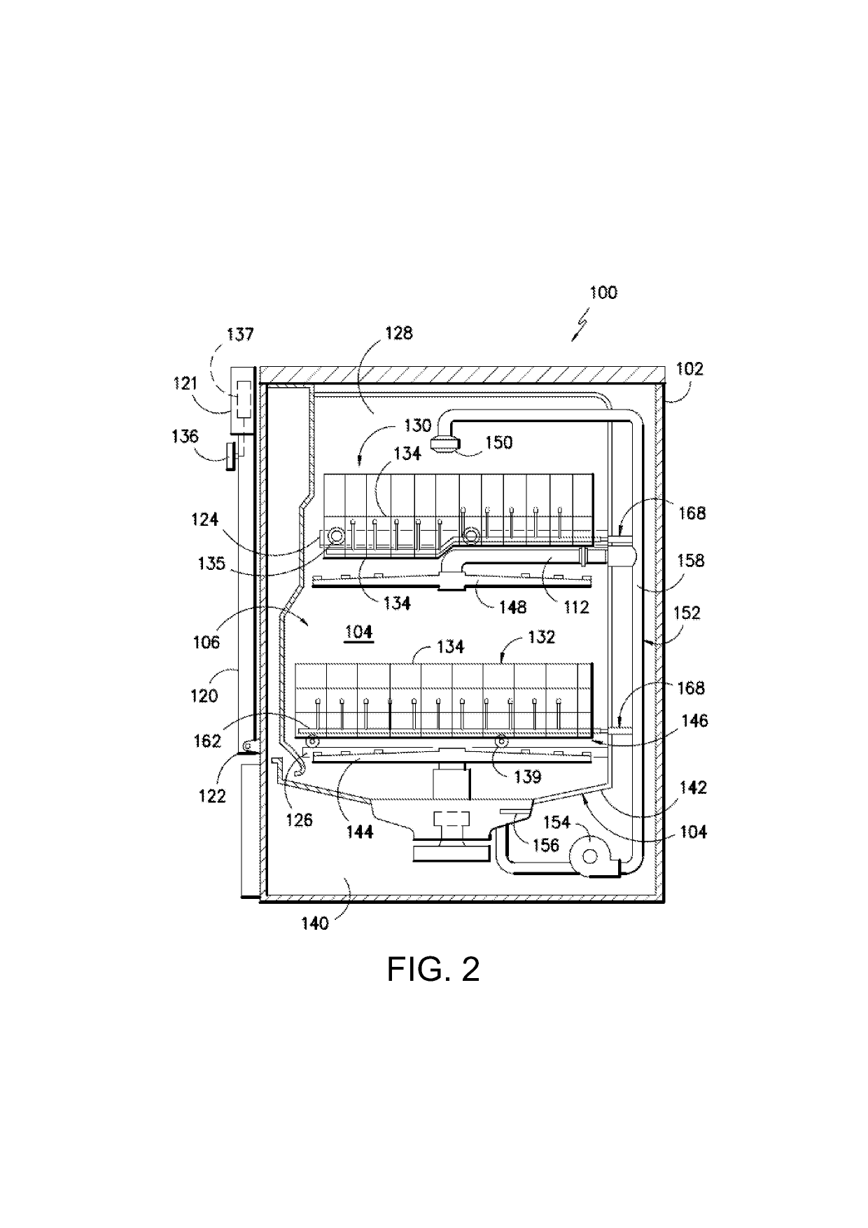

FIGS. 1 and 2 depict an exemplary domestic dishwasher 100 that may be configured in accordance with aspects of the present disclosure. For the particular embodiment of FIG. 1, the dishwasher 100 includes a cabinet 102 having a tub 104 therein that defines a wash chamber 106. The tub 104 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 may be mounted on or integral with tub side walls 128 and accommodate roller-equipped rack assemblies 130 and 132. Each of the rack assemblies 130, 132 is fabricated into lattice structures including a plurality of elongated members 134 (for clarity of illustration, not all elongated members making up assemblies 130 and 132 are shown in FIG. 2). Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively.

Dishwasher 100 further includes a lower spray-arm assembly 144 that is rotatably mounted within a lower region 146 of the wash chamber 106 and above a tub sump portion 142 so as to rotate in relatively close proximity to rack assembly 132. A heater 156 may be provided in the bottom sump portion 142 of the tub 104 or between the tub bottom and lower spray arm assembly 144 for heating the washing water and the air in the wash chamber 106 (not illustrated). Mid-level spray-arm assembly 148 is located in an upper region of the wash chamber 106 and may be located in close proximity to upper rack 130. Additionally, an upper spray assembly 150 may be located above the upper rack 130.

The lower and mid-level spray-arm assemblies 144, 148 and the upper spray assembly 150 are fed by a fluid circulation assembly 152 for circulating water and dishwasher fluid in the tub 104. The fluid circulation assembly 152 may include a pump 154 located in a machinery compartment 140 located below the bottom sump portion 142 of the tub 104, as generally recognized in the art. Each spray-arm assembly 144, 148 includes an arrangement of discharge ports or orifices for directing washing liquid onto dishes or other articles located in rack assemblies 130 and 132. Mid-level spray-arm assembly 148 may be connected to fluid circulation assembly 158 through manifold 112. The arrangement of the discharge ports in spray-arm assemblies 144, 148 provides a rotational force by virtue of washing fluid flowing through the discharge ports. The resultant rotation of the lower spray-arm assembly 144 provides coverage of dishes and other dishwasher contents with a washing spray.

Supply conduit 162 includes a connecting end configured for mating connection with a docking port 168 located at the rear of dishwasher 100. Port 168 is connected with fluid circulation assembly 152 such that the wash and/or rinse fluids may be supplied to upper and lower rack assemblies 130 and 132 through supply conduit 162.

Supply conduit 162 can be provided as a separate element that is positioned near the bottom wall 119 of rack assembly 132 as shown in FIG. 2. However, other constructions may be used as well. For example, supply conduit 162 could be constructed to appear as one of the elongated elements 134 that creates walls of rack assembly 132.

Operation of the dishwasher 100 is regulated by a controller 137 which is operatively coupled to a user interface panel 121 having an input 136 for user manipulation to select dishwasher machine cycles and features. In response to user manipulation of the user interface input 136, the controller 137 operates the various components of the dishwasher 100 and executes selected machine cycles and features. The controller may include a memory and microprocessor, CPU or the like, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area of door 120 as shown. In such an embodiment, input/output (“I/O”) signals may be routed between the control system and various operational components of dishwasher 100 such as the heater 156 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the invention is not limited to any particular style, model, or other configuration of dishwasher, and that the embodiment depicted in FIGS. 1 and 2 is for illustrative purposes only. Other configurations and appliances including a heater may be used as well such as, a washer, a dryer, a microwave, a cooking range, and a refrigerator.

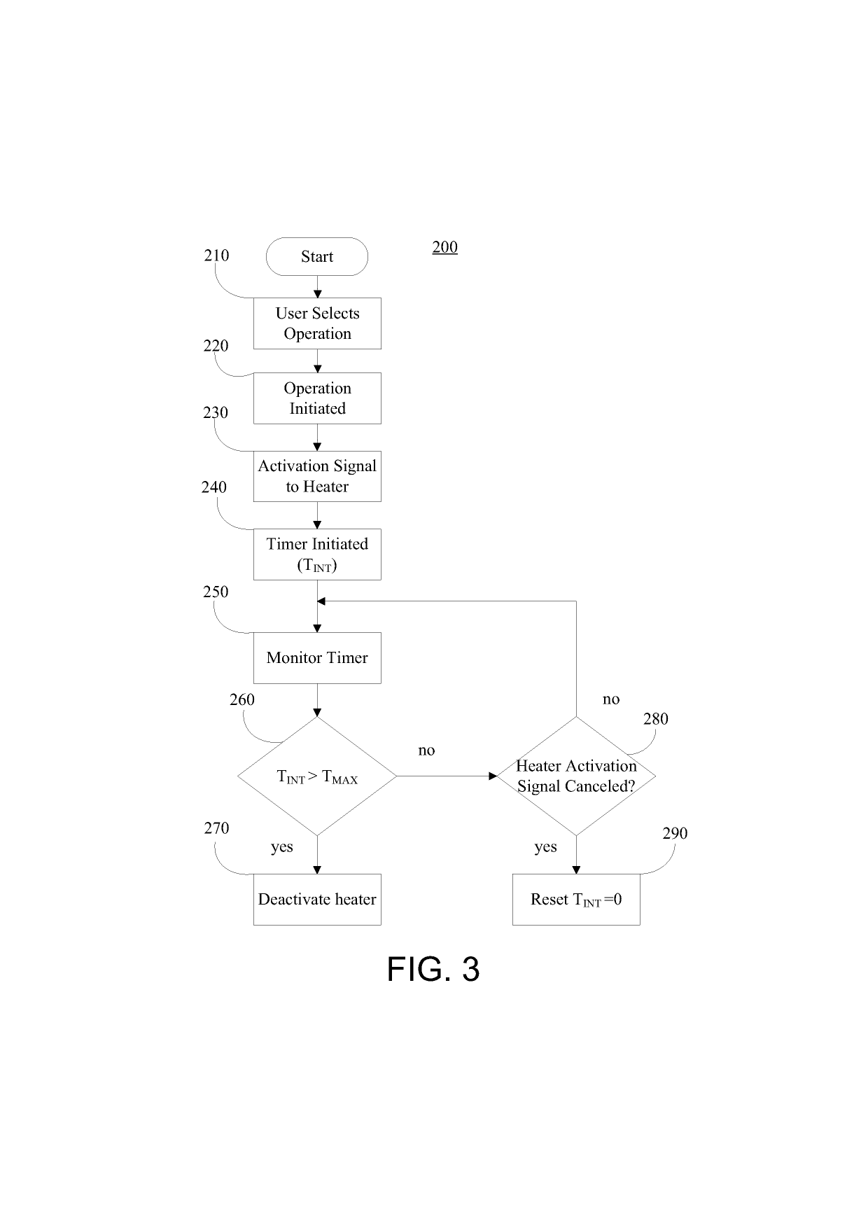

FIG. 3 provides a flow chart of exemplary method steps for preventing prolonged heater operation in an appliance. The method 200 may be implemented by the controller 137 of the dishwasher 100 described above or it may be implemented by any appliance that includes a heater. However, the controller 137 does not have to implement all steps in method 200, as described below. In this exemplary embodiment, the method 200 includes the following steps. Beginning at 210, a user selects a desired operation cycle. This operation may include a wash, rinse, dry or sanitize cycle. After the operation is selected, the controller 137 may begin initiating or regulating the operation of the dishwasher or appliance as in step 220. For example, the controller 137 may send a signal to the fluid circulation assembly 152 to begin introducing water into the wash chamber 106. The controller 137 may also send a signal to the heater 156 to activate the heater during the operation cycle.

When the heater 156 is activated in step 230, a timer is initiated (T_{INT}) at step 240 to measure the duration the heater is activated. The timer may be within the controller 137 or it may be a separate and distinct device that acts independently of controller 137. The timer may be initiated by the controller 137 or may be self-initializing. During the operation, the timer may be started and stopped with the deactivation and reactivation of the heater and may be reset to zero when the heater 137 is deactivated. If the heater 156 is activated a plurality of times during the operation cycle, the timer may be initiated only with the first activation, only with the last activation or with any or all activations that occur during the operation cycle.

In step 250, the controller 137 may monitor the timer to determine the duration the heater is activated or the monitoring may be done within the timer. A predetermined maximum time limit (T_{MAX}) may be set to correlate with a time period that would prevent damage to the appliance if the heater were to remain activated. At step 260, a current timer measurement may be compared to the predetermined maximum time limit to determine whether the current timer measurement exceeds the predetermined maximum time limit. If the current timer measurement exceeds the predetermined maximum time limit, in step 270, a heater relay or switching device may be opened and the heater 156 may be deactivated. Alternatively, if the current timer measurement does not exceed the predetermined maximum time limit, it may be determined whether the activation signal to the heater was canceled, in step 280. Some ways an activation signal may be canceled include a user interrupting the cycle before completion of the cycle or the cycle completing the normal operation. When it is determined that the heater activation signal was not canceled, the method 200 returns to the step of monitoring the timer 250. When the heater activation signal is determined to be canceled, the timer is reset to zero in step 290. After step 290, the operation of the user selected operation may be complete. However, if it is not complete and the heater is activated again, the system may return to step 240 to re-initiate the timer.

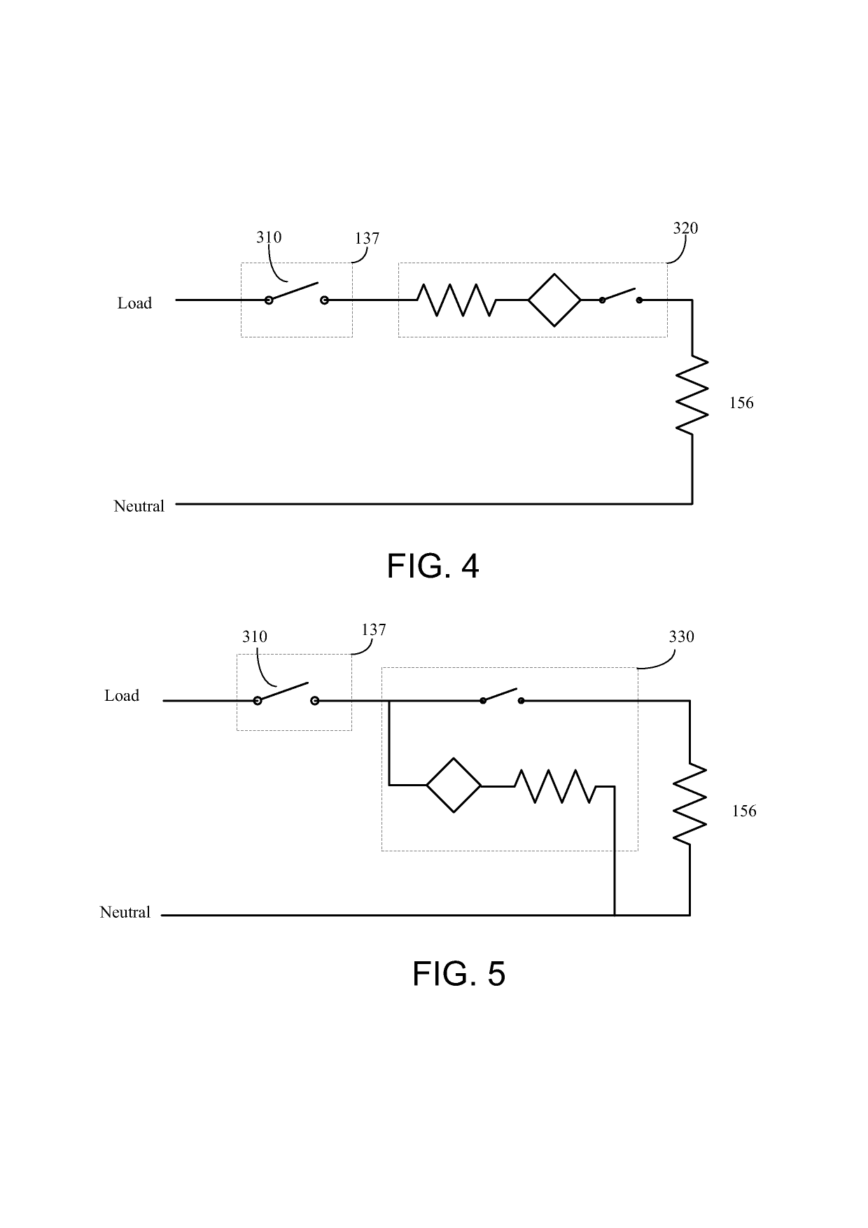

Heater 156 may be deactivated through a heater relay 310 and/or a timer switch circuit configuration. FIGS. 4 and 5 are exemplary embodiments of alternative configurations of the timer switch in communication with the heater 156. In FIG. 4, the timer switch 320 may be positioned on the load line and in series with the controller 137 and the heater 156, where the controller 137 may include the heater relay 310. The controller 137 may open the heater relay 310 and the timer switch 320 may be opened to deactivate the heater element 156 thereby preventing current and voltage from influencing the heater 156. Also, the timer switch 320 may be opened independent of controller 137.

Alternatively, as shown in FIG. 5, timer switch 330 may be positioned in parallel with the heater. This configuration may prevent current from being conducted to heater 156 but may allow voltage to still reach timer switch circuitry 330. Because voltage may still influence the timer switch 330, heater relay 310 and/or timer switch 330 may be closed thereby resetting the heater circuit and may allow normal appliance operations to resume without requiring service. Other configurations of a circuit for deactivating the heater once a predetermined time limit has been exceeded may be used as well.

A timer switch may be reset based on the type of heater disengagement or deactivation. For example, in a permanent disengagement, a new part may be required to reset the appliance to perform normal operations. In a manual resettable disengagement, service to the appliance may be needed to reset the appliance to perform normal operations. Also, an automatic disengagement may occur and the heater may be re-engaged after a predetermined time period.

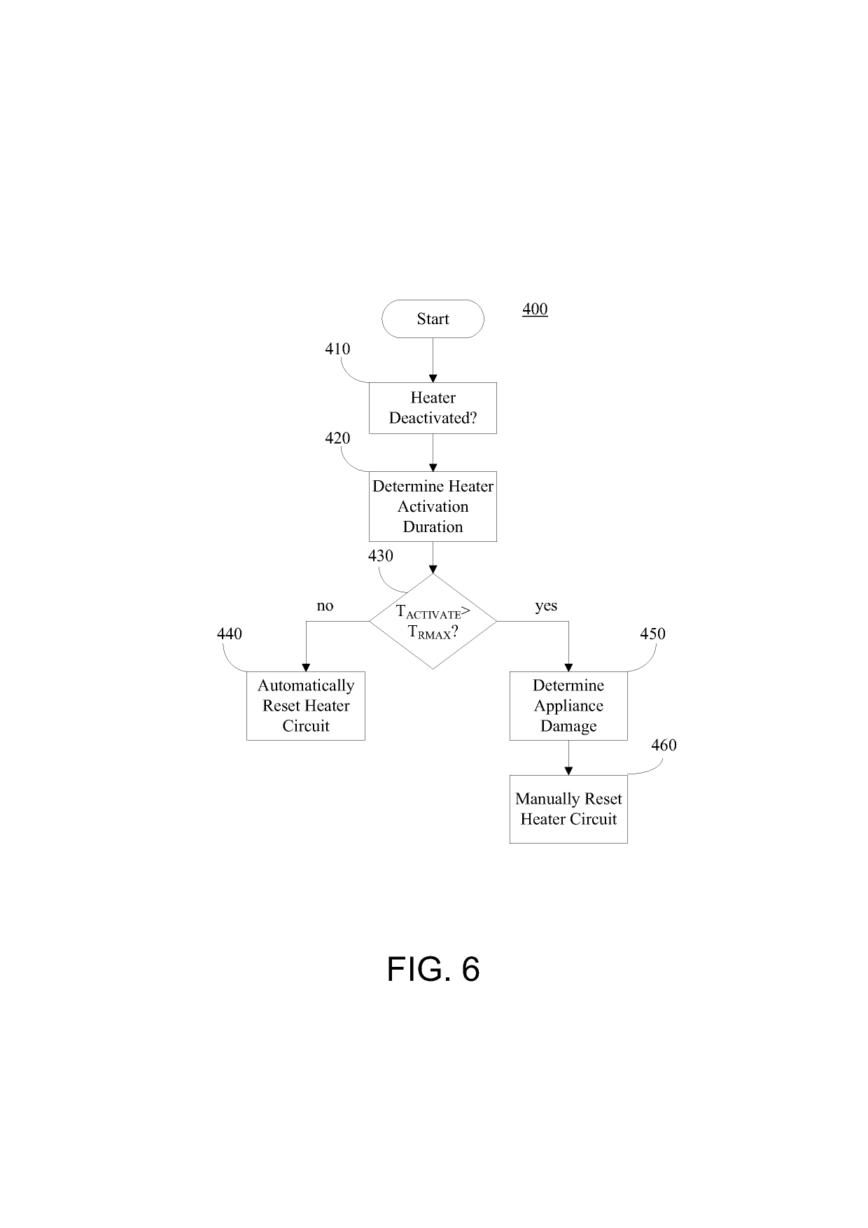

FIG. 6 provides a flow chart of exemplary steps for reactivating the timer switch circuit after the heater was deactivated to prevent prolonged heater operation. The method 400 may be implemented by controller 137 or may be implemented by alternative means such as manually. In this exemplary embodiment, the method 400 includes the following steps. Starting at 410, it may be determined that the heater was deactivated to prevent prolonged heater operation. After it is determined that the heater was deactivated, the duration the heater was activated may be determined at step 420. A predetermined reset maximum time limit (T_{RMAX}) may be set and if the duration the heater was activated (T_{ACTIVATE}) is less than the predetermined time limit (T_{ACTIVATE}<T_{RMAX}), the heater relay and/or timer switch may be automatically closed and the heater circuit reset to continue normal appliance operations in step 440. However, if the duration the heater was activated is greater than the predetermined time limit (T_{ACTIVATE}>T_{RMAX}), the heater circuit may be reset by a serviceman as in step 460 who may first determine in step 450 if any damage to the appliance occurred.

When damage has occurred to the appliance, the serviceman may determine how the damage occurred, if it is likely that the damage will reoccur or the cause of the heater deactivation. The serviceman may make any necessary repairs to the appliance and then manually reset the heater circuit, as in step 460 to allow the device to continue with normal operations that include heater activation.

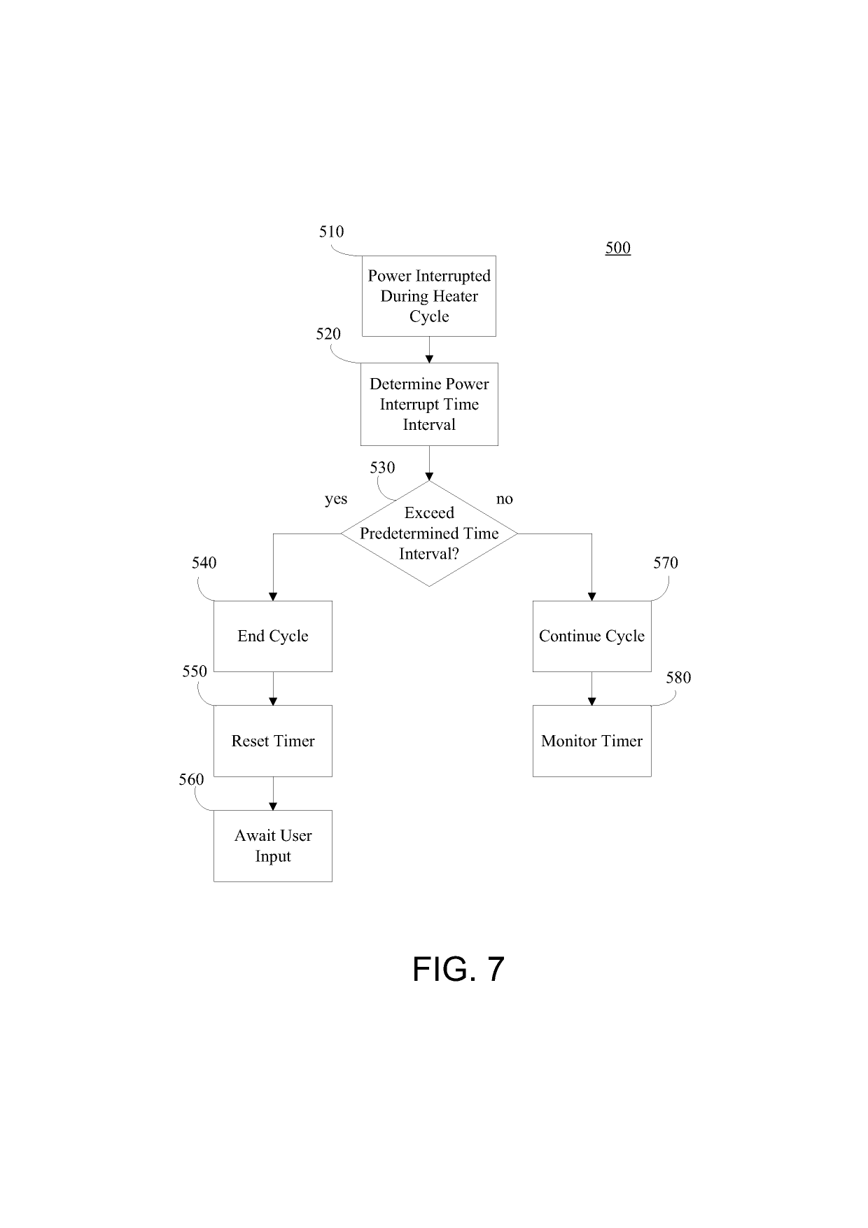

At any time during operation, the appliance may experience a power outage. The power outage may be an intended power outage, such as a user initiated interrupt where the door to the appliance is opened. Alternatively, the outage may be unintended such as a spike in the power or a total power outage over the network. FIG. 7 provides a flow chart of exemplary steps for managing power outages. The method 500 may be implemented by any available means such as by controller 137 or manually. Starting at 510, a power interrupt may happen during a cycle where the heater is activated. When a power interrupt occurs, after determining the duration of power loss, as in step 520, it may be determined whether the time interval of power loss exceeds a predetermined time interval as in step 530. For example, when a power spike occurs in the electric network, this may only be a few seconds of power loss or a power outage in the network could last days. Alternatively, if the power outage is contributed to a user opening the door, the door may be quickly shut or it may inadvertently be left open for an extended period of time.

If a power interruption is determined to exceed a predetermined time interval, the appliance may end the cycle that was operating at the time of power loss, as in step 540, allowing no further cycles to proceed after power is restored to the appliance. Then the timer may be reset, as in step 550, and the appliance may go into standby mode, awaiting a user input, as in step 560.

However, if a power interruption does not exceed a predetermined time interval when power is restored to the appliance, the appliance may continue the cycle from the point at which power was lost, as in step 570. If the cycle continues, the timer may not be reset and monitoring of the timer will continue, as in step 580, similarly to step 250.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub that defines a chamber for receipt of articles for cleaning;
a heater for producing heat in said tub;
a timer for measuring a duration said heater is activated (T_{ACTIVATE}), wherein said timer includes a timer switch;
a controller in communication with said heater, wherein said controller:
regulates operation of the dishwasher,
controls said heater based on a selected operation; and
a time limit determination apparatus that determines when said heater exceeds a predetermined maximum time limit (T_{MAX}), wherein said heater is deactivated when the duration said heater is activated exceeds the predetermined maximum time limit (T_{INT}>T_{MAX}).

2. The dishwasher appliance as in claim 1, wherein said controller initiates the timer upon initial activation of said heater.

3. The dishwasher appliance as in claim 2, wherein said controller resets the timer to zero when said heater is deactivated during the operation of the dishwasher.

4. The dishwasher appliance as in claim 1, wherein said heater is deactivated by opening a heater relay or the timer switch when it is determined that the timer measurement exceeds the predetermined time limit.

5. The dishwasher appliance as in claim 4, wherein the timer switch is in series or parallel with said heater.

6. The dishwasher appliance as in claim 1, further comprising a power outage manager that reactivates said heater and said timer after power is interrupted during heater activation.

7. The dishwasher appliance as in claim 1, wherein said controller reactivates said heater after a predetermined time period (T_{RESET}) when deactivating said heater has occurred.

8. The dishwasher appliance as in claim 4, wherein said controller closes the heater relay or the timer switch after a predetermined time period (T_{RESET}) when deactivating said heater has occurred.

9. The dishwasher appliance as in claim 1, wherein said time limit determination apparatus is said timer.

10. The dishwasher appliance, as in claim 1, wherein said time limit determination apparatus is said controller.

11. A method for preventing prolonged heater operation in an appliance, the method comprising the steps of:
regulating operation of the appliance by a controller;
controlling a heater based on a selected operation;
initiating a timer for measuring a duration the heater is activated during the selected operation (T_{INT});
determining whether the heater exceeds a predetermined maximum time limit (T_{MAX}); and
deactivating the heater when the duration the heater is activated exceeds the predetermined maximum time limit (T_{INT}>T_{MAX}).

12. The method of claim 11, wherein said initiating the timer step begins upon initial activation of the heater.

13. The method of claim 11, further comprising the step of resetting the timer to zero when the heater is deactivated during the operation of the washer.

14. The method of claim 13, further comprising a step of reinitiating the timer for measuring the duration the heater is activated during a subsequent operation.

15. The method of claim 11, wherein during said deactivating the heater step a heater relay or timer switch is opened.

16. The method of claim 11, further comprising a step of reactivating the heater after a predetermined time period (T_{RESET}) when deactivating said heater has occurred.

17. The method of claim 11, wherein the appliance is selected from at least one of a dishwasher, a washer, a dryer, a microwave, a cooking range, and a refrigerator.

18. The method of claim 11, wherein the steps of controlling the heater, initiating the timer, determining whether the heater exceeds a predetermined maximum time limit and deactivating the heater are performed by the controller.

19. The method of claim 11, wherein the steps of initiating the timer, determining whether the heater exceeds a predetermined maximum time limit and deactivating the heater are performed by timer switch circuitry.

20. The method of claim 11, further comprising a step of managing a power outage when power is interrupted during heater activation.
